(19) United States
(12) Patent Application Publication
(10) Pub. No.: US 2014/0165575 A1
(43) Pub. Date: Jun. 19, 2014

(54) NOZZLE SECTION FOR A GAS TURBINE ENGINE

(71) Applicant: UNITED TECHNOLOGIES CORPORATION, Hartford, CT (US)

(72) Inventors: Felix Izquierdo, Palm Beach Gardens, FL (US); Timothy J. McAlice, Jupiter, FL (US)

(73) Assignee: United Technologies Corporation, Hartford, CT (US)

(21) Appl. No.: 13/713,819

(22) Filed: Dec. 13, 2012

(51) Int. Cl. F02C 7/00

(52) U.S. Cl. CPC F02C 7/00
USPC 60/772; 60/722

(57) ABSTRACT

A gas turbine engine includes a fan section and an intercooling turbine section along an engine axis aft of a fan section and forward of a combustor section.

### STATEMENT REGARDING FEDERALLY SPONSORED RESEARCH OR DEVELOPMENT

This disclosure was made with Government support under N00019-02-C3003 awarded by The United States Navy. The Government has certain rights in this disclosure.

### BACKGROUND

The present disclosure relates to variable cycle gas turbine engines, and more particularly to a nozzle section therefor.

Variable cycle gas turbine engines power aircraft over a range of operating conditions yet achieve countervailing objectives such as high specific thrust and low fuel consumption. The variable cycle gas turbine engine essentially alters a bypass ratio during flight to match requirements. This facilitates efficient performance over a broad range of altitudes and flight conditions to generate high thrust for high-energy maneuvers yet optimize fuel efficiency for cruise and loiter.

An exhaust nozzle optimizes the thrust produced by the gas turbine engine. In variable cycle gas turbine engines, each of the airflow streams may require a particular nozzle.

### SUMMARY

A nozzle section for a gas turbine engine according to one disclosed non-limiting embodiment of the present disclosure includes a multiple of circumferentially overlapping flaps.

In a further embodiment of the foregoing embodiment, each one of the multiple of circumferentially overlapping flaps overlaps an adjacent circumferential overlapping flap.

In a further embodiment of any of the foregoing embodiments, the multiple of circumferentially overlapping flaps are hinged to engine case structure.

In a further embodiment of any of the foregoing embodiments, the multiple of circumferentially overlapping flaps is hinged inboard of an airflow path. In the alternative or additionally thereto, in the foregoing embodiment the airflow path is a non-primary airflow path. In the alternative or additionally thereto, in the foregoing embodiment the airflow path is annular. In the alternative or additionally thereto, in the foregoing embodiment the airflow path is a third stream airflow path. In the alternative or additionally thereto, in the foregoing embodiment the airflow path is radially outboard of a primary airflow path that exhausts through a convergent divergent nozzle. In the alternative or additionally thereto, in the foregoing embodiment the airflow path is radially outboard of a primary airflow path that exhausts through a two-dimensional nozzle.

In a further embodiment of any of the foregoing embodiments, further comprising an actuator system to control the multiple of circumferentially overlapping flaps. In the alternative or additionally thereto, in the foregoing embodiment the actuator system includes an actuator connected to each of the multiple of circumferentially overlapping flaps.

A variable cycle gas turbine engine with a primary airflow path and non-primary airflow path according to another disclosed non-limiting embodiment of the present disclosure includes a multiple of circumferentially overlapping flaps in communication with the non-primary airflow path.

In a further embodiment of the foregoing embodiment, the primary airflow path is radially inboard of the non-primary airflow path.

In a further embodiment of any of the foregoing embodiments, the non-primary airflow path is annular.

In a further embodiment of any of the foregoing embodiments, the non-primary airflow path is a third stream airflow path.

In a further embodiment of any of the foregoing embodiments, the primary airflow path is radially inboard of the non-primary airflow path, the primary airflow path exhausts through a convergent-divergent nozzle.

In a further embodiment of any of the foregoing embodiments, the primary airflow path is radially inboard of the non-primary airflow path, the primary airflow path exhausts through a two-dimensional nozzle.

A method of operating a gas turbine engine, according to another disclosed non-limiting embodiment of the present disclosure includes modulating a nozzle section in communication with a non-primary airflow path radially outboard of a primary airflow path.

In a further embodiment of the foregoing embodiment, further comprising circumferentially overlapping a multiple of flaps to selectively vary an annular opening of the non-primary airflow path.

In a further embodiment of any of the foregoing embodiments, further comprising pivoting the nozzle section in communication with the non-primary airflow path between the non-primary airflow path and the primary airflow path.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic view of an exemplary variable cycle gas turbine engine according to one non-limiting embodiment;

FIG. 2 is a lateral cross section of an exhaust duct section according to one non-limiting embodiment;

FIG. 3 is a lateral cross section of an exhaust duct section according to another non-limiting embodiment;

FIG. 4 is a lateral cross section of an exhaust duct section according to another non-limiting embodiment;

FIG. 5 is a schematic view of a serpentine exhaust duct section according to another non-limiting embodiment;

FIG. 6 is an exhaust duct section with a two-dimensional nozzle section according to another non-limiting embodiment;

FIG. 7 is an expanded longitudinal cross-sectional view of nozzle section according to one disclosed non-limiting embodiment;

FIG. 8 is an partial rear view of a non-primary airflow nozzle according to one disclosed non-limiting embodiment looking aft to forward;

FIG. 9 is an partial sectional view of the non-primary airflow nozzle in an open position;

FIG. 10 is an partial sectional view of the non-primary airflow nozzle in a closed position;

FIG. 11 is a schematic end view of the non-primary airflow nozzle with an actuator system according to one disclosed non-limiting embodiment;

FIG. 12 is a schematic end view of the non-primary airflow nozzle with an actuator system according to another disclosed non-limiting embodiment;

FIG. 13 is a schematic end view of the non-primary airflow nozzle with an actuator system according to another disclosed non-limiting embodiment; and

FIG. 14 is a schematic end view of the non-primary airflow nozzle with an actuator system according to another disclosed non-limiting embodiment.

### DETAILED DESCRIPTION

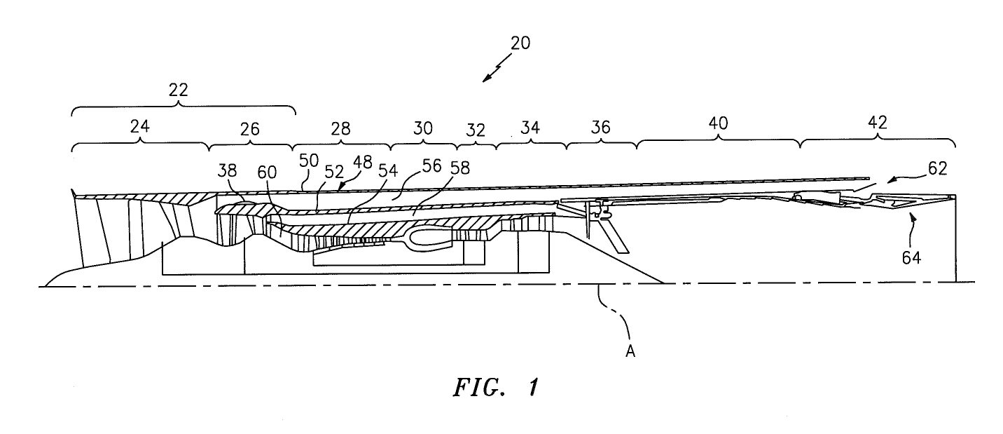

FIG. 1 schematically illustrates a gas turbine engine 20. The gas turbine engine 20 is disclosed herein as a variable cycle two-spool bypass turbofan that generally includes: a fan section 22 with a first stage fan section 24 and a second stage fan section 26; a high pressure compressor section 28; a combustor section 30; a high pressure turbine section 32; a low pressure turbine section 34; an augmentor section 36; an exhaust duct section 40; and a nozzle section 42. Additional sections, systems and features such as a geared architecture that may be located in various engine sections, for example, forward of the second stage fan section 26 or aft of the low pressure turbine section 34. The sections are defined along a central longitudinal engine axis A.

The engine 20 generally includes a low spool 44 and a high spool 46 that rotate about the engine central longitudinal axis A relative to an engine case structure 48. Other architectures, such as three-spool architectures, will also benefit herefrom.

The engine case structure 48 generally includes an outer case structure 50, an intermediate case structure 52 and an inner case structure 54. It should be understood that various structures individual or collectively may define the case structures 48 to essentially define an exoskeleton that supports the spools 44, 46 for rotation therein.

The first stage fan section 24 communicates airflow through a flow control mechanism 38 into a third stream airflow path 56 as well as into a second stream airflow path 58 and a core primary airflow path 60 that is in communication with the augmentor section 36. The flow control mechanism 38 may include various structures such as pneumatic or mechanical operated blocker doors that operate as a throttle point to define a variable area throat. The flow control mechanism 38 is selectively operable to control airflow through the third stream airflow path 56 such that a selective percentage of airflow from the first stage fan section 24 is divided between the third stream airflow path 56 as well as both the second stream airflow path 58 and core primary airflow path 60. In the disclosed non-limiting embodiment, the flow control mechanism 38 may throttle the flow into the third stream airflow path 56 down to a minimal but non-zero flow.

The second stage fan section 26 communicates airflow into the second stream airflow path 58 and the primary airflow path 60. The second stage fan section 26 generally is radially inboard and downstream of the flow control mechanism 38 such that all flow from the second stage fan section 26 is communicated into the second stream airflow path 58 and the primary airflow path 60. The fan section 22 may alternatively or additionally include other architectures that, for example, include additional or fewer stages each with or without various combinations of variable or fixed guide vanes.

The core primary airflow is compressed by the first stage fan section 24, the second stage fan section 26, the high pressure compressor section 28, mixed and burned with fuel in the combustor section 30, then expanded over the high pressure turbine section 32 and the low pressure turbine section 34. The turbines sections 32, 34 rotationally drive the respective low spool 44 and high spool 46 in response to the expansion. Each of the turbine sections 32, 34 may alternatively or additionally include other architectures that, for example, include additional or fewer stages each with or without various combinations of variable or fixed guide vanes.

The third stream airflow path 56 is generally annular in cross-section and defined by the outer case structure 50 and the intermediate case structure 52. The second stream airflow path 58 is also generally annular in cross-section and defined by the intermediate case structure 52 and the inner case structure 54. The core primary airflow path 60 is generally circular in cross-section and defined by the inner case structure 54. The second stream airflow path 58 is defined radially inward of the third stream airflow path 56 and the core primary airflow path 60 is radially inward of the core primary airflow path 60. Various crossover and cross-communication airflow paths may alternatively or additionally provided.

The nozzle section 42 may include a third stream exhaust nozzle 62 (illustrated schematically) which receives flow from the third stream airflow path 56 and a mixed flow exhaust nozzle 64 (illustrated schematically) which receives a mixed flow from the second stream airflow path 58 and the core primary airflow path 60. It should be understood that various fixed, variable, convergent/divergent, two-dimensional and three-dimensional nozzle systems may be utilized herewith.

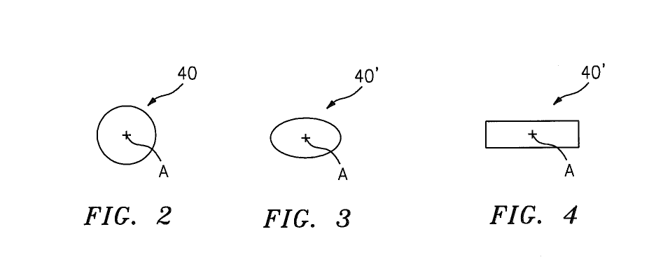

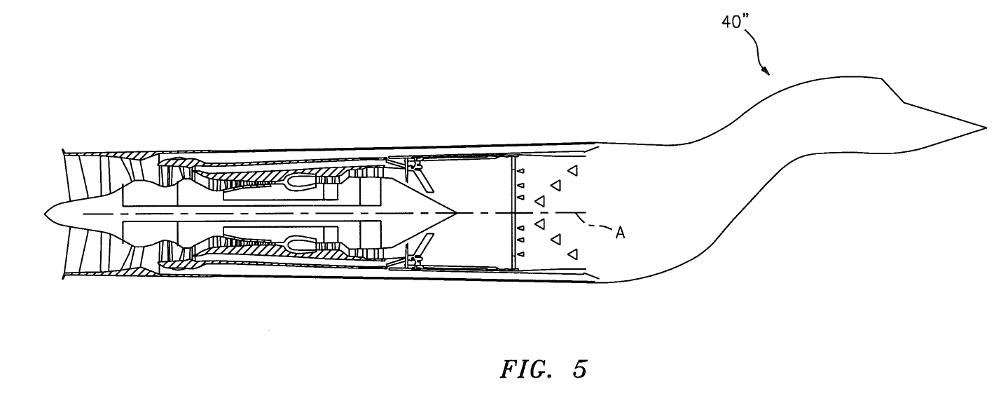

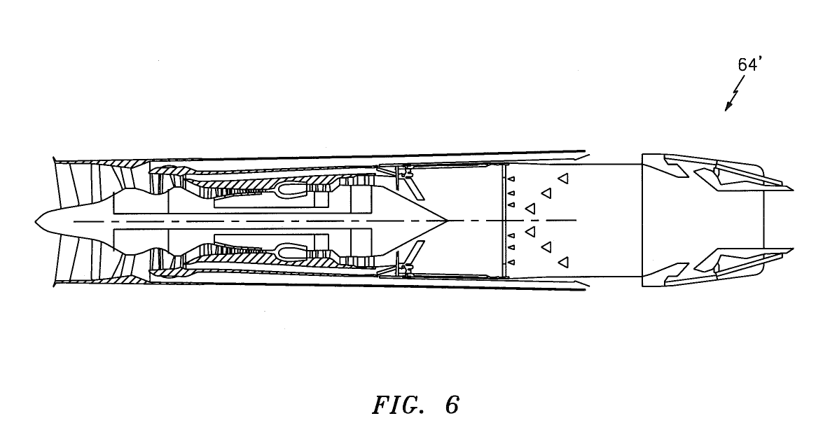

With reference to FIG. 2, the exhaust duct section 40 may be circular in cross-section as typical of an axis-symmetric augmented low bypass turbofan. In another disclosed non-limiting embodiment the exhaust duct section 40′ may be non-axisymmetric in cross-section to include, but not be limited to, an oval cross-section (FIG. 3) a rectilinear cross-section (FIG. 4) or other shape. In addition to the various cross-sections, the exhaust duct section 40″ may be non-linear with respect to the central longitudinal engine axis A to form, for example, a serpentine shape to block direct view to the turbine section (FIG. 5). Furthermore, in addition to the various cross-sections and the various longitudinal shapes, the exhaust duct section 40 may terminate in a convergent divergent mixed flow exhaust nozzle 64 (FIG. 1), a non-axisymmetric two-dimensional (2D) vectorable mixed flow exhaust nozzle 64′ (FIG. 6), or other exhaust arrangement.

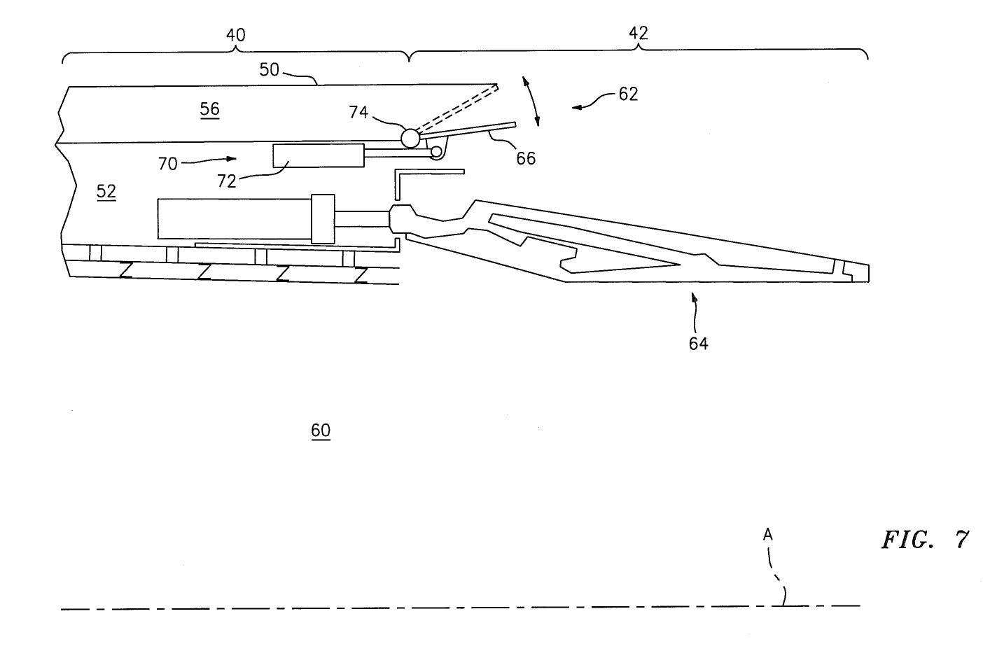

With reference to FIG. 7, the third stream exhaust nozzle 62 receives and controls flow from the third stream airflow path 56. The third stream exhaust nozzle 62 is radially outboard of the mixed flow exhaust nozzle 64 and may be positioned, axially equal, upstream (shown), or downstream of the mixed flow exhaust nozzle 64. The third stream exhaust nozzle 62 provides aerodynamic control for flow from the third stream airflow path 56 to operate the engine at various cycle points to, for example, enhance both operability and efficiency.

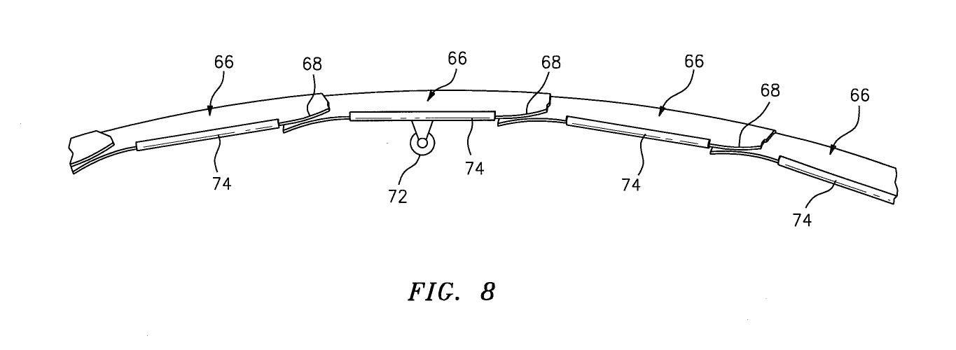

The third stream exhaust nozzle 62 includes a multiple of circumferentially overlapping flaps 66 (also shown in FIG. 8). That is, each flap 66 of the multiple of circumferentially overlapping flaps 66 at least partially circumferentially overlaps an adjacent flap 66 in a unidirectional relationship such that movement of one flap 66 moves the other flaps 66 between an open position (FIG. 9) and a closed position (FIG. 10). The multiple of circumferentially overlapping flaps 66 thereby form a variable annulus to selectively throttle the third stream airflow path 56. The multiple of circumferentially overlapping flaps 66 are also generally planar but arcuate and need not provide a convergent-divergent flow path.

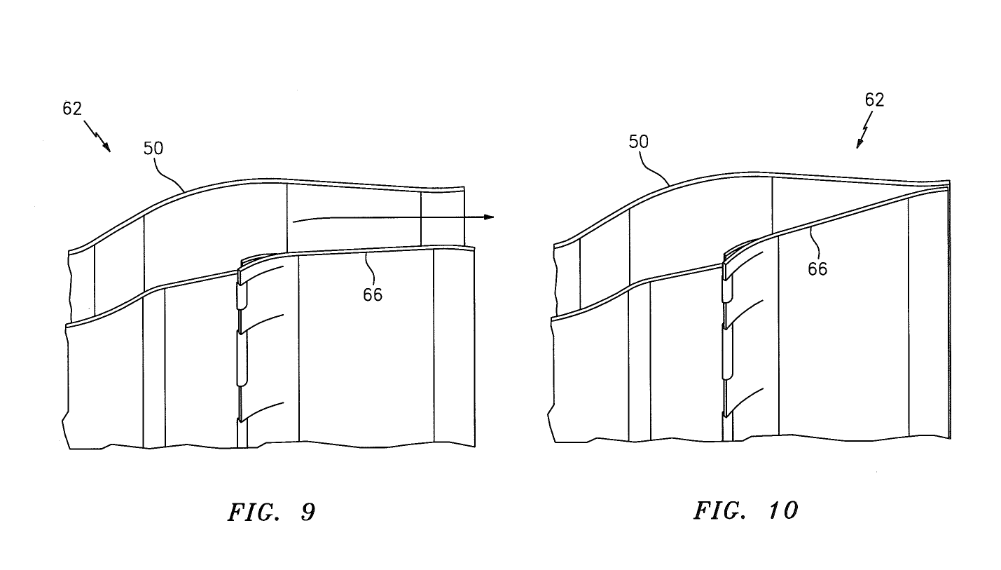

As each flap 66 at least partially overlaps an adjacent flap 66, an actuator system 70 (illustrated schematically) need only include a single actuator 72 attached to a single flap 66 to control the multiple of circumferentially overlapping flaps 66 between the open position (FIG. 9) and the closed position (FIG. 10). In an alternative non-limiting embodiment, an actuator 72 may be attached to every flap 66 to control the multiple of circumferentially overlapping flaps 66 (FIG. 11). That is, a unilateral sliding interface 68 (FIG. 8) is provided there between. In another alternative non-limiting embodiment, an actuator 72 may be attached to a subset of flaps 66 to control the multiple of circumferentially overlapping flaps 66 (FIG. 12). For example only, an actuator 72 is connected to four (4) flaps 66 at a 0, 90, 180 and 270 degree position yet actuates the multiple of circumferentially overlapping flaps 66 in their entirety.

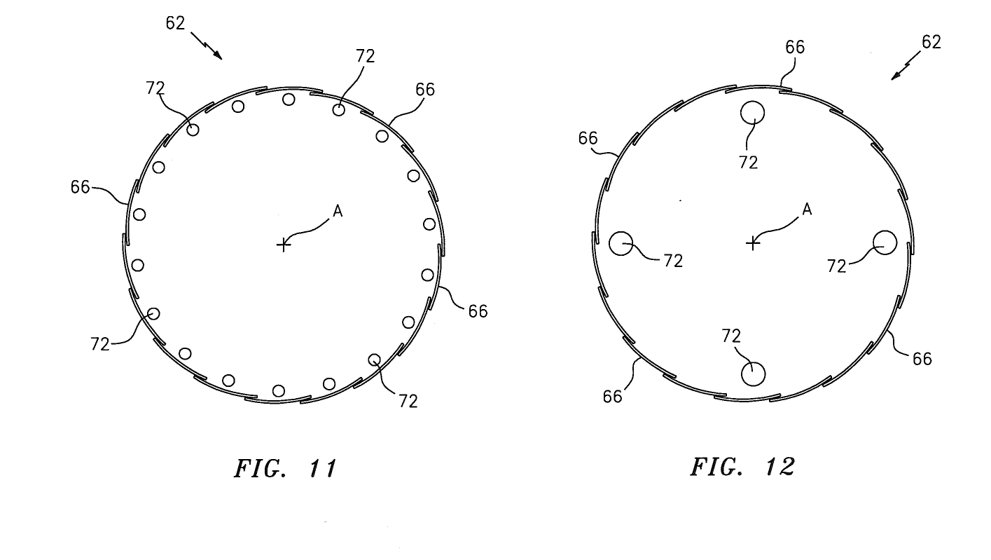

Each flap 66 of the multiple of circumferentially overlapping flaps 66 are hinged at a hinge 74 that is mounted to the intermediate case structure 52 between the third stream airflow path 56 and the core primary airflow path 60 with the exhaust duct section 40. Alternatively, the hinge 74 may be mounted to the outer case structure 50 (FIG. 13). Furthermore, the third stream exhaust nozzle 62 may be located in other axial and radial positions, for example, axially downstream of the mixed flow exhaust nozzle 64 and/or radially inboard of the mixed flow exhaust nozzle 64 (FIG. 14).

It should be understood that relative positional terms such as “forward,” “aft,” “upper,” “lower,” “above,” “below,” and the like are with reference to the engine but should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed in the illustrated embodiment, other arrangements will benefit herefrom.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A nozzle section for a gas turbine engine comprising:
a multiple of circumferentially overlapping flaps.

2. The nozzle section as recited in claim 1, wherein each one of said multiple of circumferentially overlapping flaps overlaps an adjacent circumferential overlapping flap.

3. The nozzle section as recited in claim 1, wherein said multiple of circumferentially overlapping flaps are hinged to engine case structure.

4. The nozzle section as recited in claim 1, wherein said multiple of circumferentially overlapping flaps is hinged inboard of an airflow path.

5. The nozzle section as recited in claim 4, wherein said airflow path is a non-primary airflow path.

6. The nozzle section as recited in claim 4, wherein said airflow path is annular.

7. The nozzle section as recited in claim 4, wherein said airflow path is a third stream airflow path.

8. The nozzle section as recited in claim 4, wherein said airflow path is radially outboard of a primary airflow path that exhausts through a convergent divergent nozzle.

9. The nozzle section as recited in claim 4, wherein said airflow path is radially outboard of a primary airflow path that exhausts through a two-dimensional nozzle.

10. The nozzle section as recited in claim 1, further comprising an actuator system to control said multiple of circumferentially overlapping flaps.

11. The nozzle section as recited in claim 10, wherein said actuator system includes an actuator connected to each of said multiple of circumferentially overlapping flaps.

12. A variable cycle gas turbine engine with a primary airflow path and non-primary airflow path comprising:
a multiple of circumferentially overlapping flaps in communication with said non-primary airflow path.

13. The gas turbine engine as recited in claim 12, wherein said primary airflow path is radially inboard of said non-primary airflow path.

14. The gas turbine engine as recited in claim 12, wherein said non-primary airflow path is annular.

15. The gas turbine engine as recited in claim 12, wherein said non-primary airflow path is a third stream airflow path.

16. The gas turbine engine as recited in claim 12, wherein said primary airflow path is radially inboard of said non-primary airflow path, said primary airflow path exhausts through a convergent-divergent nozzle.

17. The gas turbine engine as recited in claim 12, wherein said primary airflow path is radially inboard of said non-primary airflow path, said primary airflow path exhausts through a two-dimensional nozzle.

18. A method of operating a gas turbine engine comprising:
modulating a nozzle section in communication with a non-primary airflow path radially outboard of a primary airflow path.

19. The method as recited in claim 18, further comprising circumferentially overlapping a multiple of flaps to selectively vary an annular opening of the non-primary airflow path.

20. The method as recited in claim 18, further comprising pivoting the nozzle section in communication with the non-primary airflow path between the non-primary airflow path and the primary airflow path.
